(19) United States
(12) Patent Application Publication
(10) Pub. No.: US 2007/0230159 A1
(43) Pub. Date: Oct. 4, 2007

(54) Lighting Device With User Interface For Light Control

(75) Inventors: Hubertus Maria Rene Cortenraad, Eindhoven (NL); Anthonie Hendrik Bergman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,627

(22) PCT Filed: May 2, 2005
(86) PCT No.: PCT/IB05/51422

§ 371 Date: Nov. 3, 2006

(30) Foreign Application Priority Data
May 5, 2004 (EP) 04101936.5

(51) Int. Cl. F21V 33/00

(52) U.S. Cl. 362/85

(57) ABSTRACT

The invention relates to a lighting device (1) comprising a lighting unit (2) and a user interface (3) for controlling the lighting colour and/or intensity of the lighting unit (2). The user interface (3) comprises a sensing device (5) with a large number of conductive elements (6), which responds to the proximity of a conductive object, like for instance a human finger pointing to the user interface (3). The user interface (3) can be based on proximity sensing or on touch-control. In both cases an element (6) on the outer surface (4) of the user interface (3) is selected, which corresponds to one of the selectable colours and/or intensities of the lighting unit (2). The selected element (6) generates an output signal which is sent to a processing unit (9), which converts this output signal into a driving signal suitable for the driver circuit (8) to drive the light sources (7).

The invention relates to a lighting device comprising a lighting unit and an interface for controlling the lighting colour and/or intensity of the lighting unit.

The invention further relates to a user interface for controlling a lighting device, an assembly of a lighting unit and a processing unit controlled by such a user interface and to a method for controlling a lighting device.

Present-day light sources mainly contain only one lighting colour and these light sources can be controlled by switching them on or off or by dimming. In the near future light sources which are capable of producing a whole spectrum of coloured light will become commonplace, also in every household. These kind of light sources will enable the creation of almost any colour and atmosphere, depending on the room or place to be lit.

As a consequence, the control of such light sources will become more complex, because besides the light intensity or brightness, also the colour aspects have to be controlled. Because the change of lighting colour is new to a lot of people, it is of importance that such a control unit will be easy to use.

It is a disadvantage of prior art technology that it does not provide an easy method for controlling light sources with a wide spectrum.

It is an object of the present invention to provide a lighting device which can be controlled in an easy and intuitive manner.

According to the present invention, this object is achieved by a lighting device comprising a lighting unit and a user interface for controlling the lighting colour and/or intensity of the lighting unit, said user interface having an outer surface provided with a mapping of selectable lighting colours and/or intensities and a sensing device for sensing a user action resulting in an output signal of the user interface, said output signal controls the lighting colour and/or intensity of the lighting unit.

The invention is based on the insight that it is very easy and intuitive for a person to control the lighting conditions in a room by just pointing at an object containing a map with all the possible colours and intensities that can be adjusted by the lighting unit.

In a preferred embodiment, the sensing device is a proximity sensing device comprising a plurality of conductive elements each being arranged to control a particular lighting colour and/or intensity.

This embodiment enables a very easy control, because it is even not required to make any contact with the user interface. It suffices to approach it and to point at it at some distance. Distances between 2 and 10 cm appear to be realistic.

In a further embodiment, the conductive elements, when in operation, have a certain charge, a change in the charge of such a conductive element by the proximity of a conductive object controls the setting of the lighting colour and/or intensity corresponding to said conductive element.

Here, by approaching the sensing device the control is based on a change in the charge on a specific conductive element. This change is measured and it is established which conductive element was approached, whereby the setting of the lighting unit is determined.

Another embodiment is characterized in that the sensing device is a touch-control device, comprising a plurality of resistive elements each being arranged to control a particular lighting colour and/or intensity when in operation, the corresponding resistive element being touched by a conductive object.

In this embodiment the user has to actually touch the sensing device of the user interface in order to select the desired colour and intensity setting of the lighting unit.

A user interface according to the present invention can be used as a remote control for a lighting unit in the room, but it will also be possible to make a lighting device of which the outer surface is part of the user interface. In this case the user interface and lighting unit are integrated and the light can be controlled by sensing the lighting unit itself. An example of such a lighting device may be a lamp suitable for use on a table.

In case the user interface is a remote control for the lighting unit, the user interface may be provided with lighting sources, such as incandescent lamps or LEDs, which give an indication of the lighting colour and the intensity of the light which the user desires to adjust in the room. In this case, the lighting sources of the user interface should preferably have a low intensity compared to the lighting unit it controls.

In a preferred embodiment, the lighting unit comprises light sources for generating the primary lighting colours red, green and blue.

In the 1931-CIE-chromaticity diagram, these primary colours will form a triangle and all the colours within this triangle can be generated by adjusting the ratio of the intensities of these three primary light sources. In particular, this enables the choice of a wide range of colour temperatures of white light, from cold light—like the light of halogen-type lamps—to warm light—like the light of conventional light bulbs.

In further embodiments the user interface is shaped as a pyramid with a polygon-shaped base, said pyramid having a symmetry axis which is oriented perpendicular to the polygon-shaped base, or as a cylinder or truncated ellipsoid having a base and a symmetry axis which is oriented perpendicular to the base.

In these embodiments it will be possible that the mapping of the colour and/or intensity has two independent directions, the colour is mapped following a rotation around the symmetry axis and the intensity is mapped in the direction of the symmetry axis.

The advantage of these embodiments is found in the very easy way the user can adjust the lighting unit. The lighting colour is controlled by rotating around the user interface. The intensity will in this example depend on the height at which the user approaches the user interface, for instance near the base gives a low intensity and going to the top increases the intensity.

The invention further relates to a user interface for controlling a lighting unit of such a lighting device, an assembly of a lighting unit and a processing unit controlled by such a user interface, as well as to a method for controlling this lighting unit.

These and other aspects of the invention will be apparent and will be elucidated by way of non-limitative examples with reference to the drawings and the embodiments described hereinafter.

In the drawings:

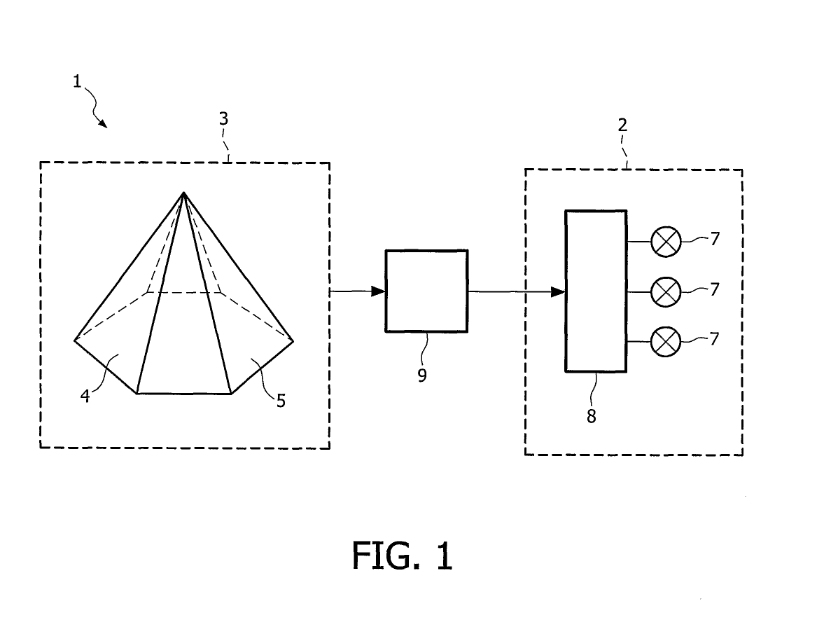

FIG. 1 is a schematic drawing of the lighting device according to the invention;

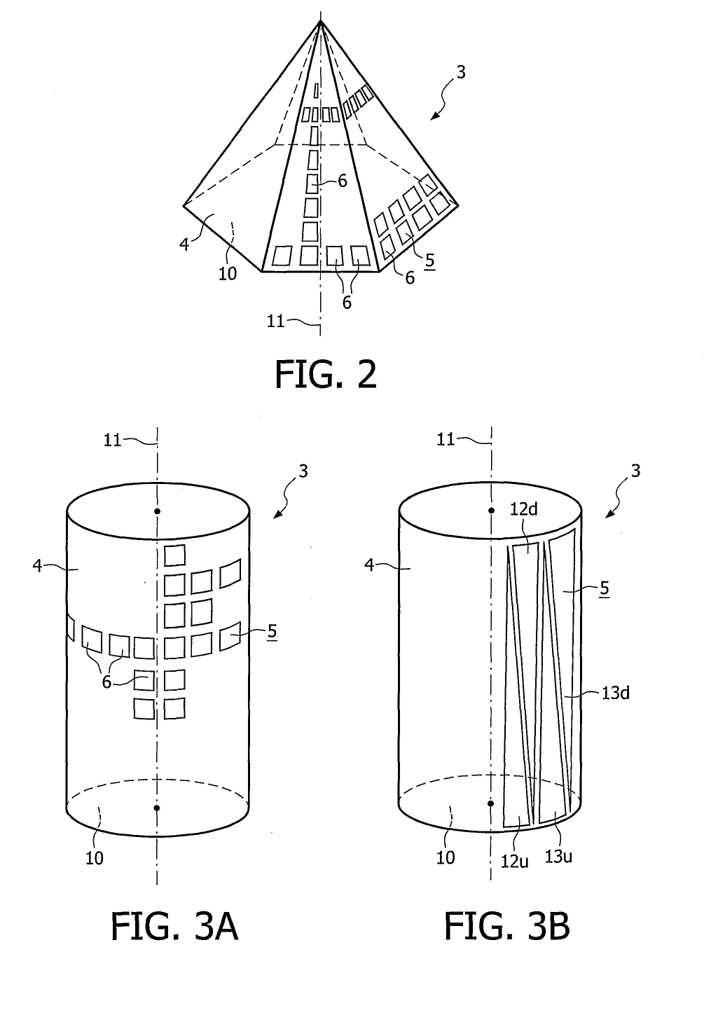

FIG. 2 gives a first embodiment according to the invention;

FIG. 3 give a second embodiment according to the invention;

In FIG. 1 a schematic overview of the different components of the lighting device 1 according to the present invention is given. The lighting device 1 comprises a lighting unit 2 and a user interface 3. The outer surface 4 of the user interface 3 has a colour mapping which can be used for selecting the desired lighting colour and/or intensity of the lighting unit 2. This selection process is controlled by a sensing device 5 which is provided on the outer surface 4. By approaching or touching the outer surface 4, this location is registered. This results in an output signal of the user interface 3 with the information needed for selecting the desired colour and intensity. This output signal is converted into a signal suitable for the driver circuit 8 to drive the light sources 7. This conversion, that is from output signal to the choice of colour and/or intensity of the lighting unit 2, is done by a processing unit 9—for instance a personal computer—which may be a separate entity, but it may also be integrated in the user interface 3 or in the lighting unit 2.

The light sources 7 may be LEDs of different colours, but also other light sources such as conventional lamps can be used.

The present invention will now be described on the basis of examples which may not be considered to limit the present invention.

A user interface 3 shaped as a pyramid with a polygon-shaped base 10 and an axis of symmetry 11 is shown in FIG. 2. The sensing device 5 is provided on the outer surface 4 of the user interface 3. In this example the sensing device 5 is composed of a two-dimensional array made up of trapezoidal elements 6 which properly fill the triangularly shaped sides of the pyramid. This sensing device 5 is based on a technique referred to as proximity sensing and works by redistribution of the charge on one or some of these elements 6. The elements 6 may be provided on a conductive foil which is charged—in a completely safe way for the user—when the user interface is in operation. When the user approaches the user interface 3 at a certain position with a conductive object, for instance his finger, the charge on the sensing device 5 will be redistributed. As a consequence, the user interface 3 will sense the proximity of this conductive object. The position at which was pointed is registered and this determines the desired setting of the lighting colour and/or the intensity of the lighting unit 2.

The two-dimensional array of elements 6 making up the mapping of selectable lighting colours and/or intensities can for instance be defined as follows. By rotating around the symmetry axis 11 the colour changes; so, a certain angle of rotation corresponds with a certain colour. If the lighting unit 2 comprises the primary colours red, green and blue it will be possible to select all kind of mixtures of these three colours. The user may choose which selection of colours he likes to map on the user interface 3; in principle he can choose from all the colours which are enclosed by the colour triangle, in the 1931-CIE-chromaticity diagram, with the primary colours as corners. The lighting unit 2 may have LEDs, incandescent lamps or other light sources.

Besides this red-green-blue colour mapping, also other types of colour mapping are possible, like e.g. the black body curve. In this case the selectable colours are all on the black body curve going from warm white—low colour temperature—to cold white—high colour temperature.

The second, independent, direction of this two-dimensional mapping can be used for selecting the intensity of the lighting unit 2. For instance, by pointing at the user interface 3 at a low level, that is near the base 10, the intensity will be low. By going upwards along the same column of elements 6 the intensity will go up, but the colour will be unaltered.

The user interface 3 can be used as a remote control for a lighting unit 2 somewhere in the room. In order to facilitate the adjusting of the desired colour and/or intensity, the user interface 3 can be made from a transparent material and can be provided with a set of for instance red, green and blue LEDs. During the selection of the desired colour and intensity these LEDs will emit light representing the colour and/or intensity chosen by the user. The intensity of the light emitted by the user interface 3 will preferably be much lower than the intensity chosen to light the room. So, in this case when the lighting is switched off, the lighting of the user interface 3 is also off. When the lighting is switched on, the user interface 3 only emits one colour of light, namely the colour that is selected for the lighting unit 2.

As an alternative, the user interface 3 may be provided with the entire colour mapping on its outer surface 4. The easiest way to do this is a passive way, that is, to provide all the elements 6 on the outer surface 4 with the colour which corresponds to the colour that can be selected by said element 6. Further, it is possible to do this in an active way using light sources and/or colour filters which should be able to represent the colours which can be generated by the lighting unit 2.

As a second option, the user interface 3 and the lighting unit 2 can be integrated to form the lighting device 1. For instance, a table lamp can be made in this way. The outer surface 4 of the user interface 3 is now also the outer surface of the lighting unit 2; so, by touching the outer surface 4 the desired lighting colour and/or intensity can be selected and the integrated lighting device 1 starts emitting the desired light.

FIG. 3A gives an alternative embodiment for the polygon-based pyramid. The user interface 3 of FIG. 3A is shaped as a cylinder which is placed on its base 10. It is provided with a two-dimensional array of elements 6 forming the sensing device 5 in a similar way to the embodiment of FIG. 2. The way to operate this embodiment is the same as the polygon-based pyramid.

FIG. 3B gives a modification on the embodiments with a two-dimensional array of elements. The outer surface 4 is provided with pairs of triangularly shaped elements. Each pair has an element pointing up 12u, 13u and has an element pointing down 12d, 13d. One pair 12u, 12d or 13u, 13d corresponds to one selectable colour. The intensity information is now derived from the height along such a pair. This can be done by comparing the change in signal between the up-element 12u, 13u and the down-element 12d, 13d. For instance, starting at the base, the intensity will be zero and only the up-elements 12u, 13u will sense the proximity of a conductive object like a human finger. Going up will increase the intensity and gradually the effect of the down-elements 12d, 13d will increase and of the up-elements 12u, 13u will decrease. At full intensity only the down-elements 12d, 13d are active. Providing the outer surface 4 with these pairs of triangularly shaped elements makes, the electronics for detecting which lighting colour and intensity is selected much simpler, because the number of elements is much lower. The intensity sensing only requires two elements for each selected colour.

These sensing devices 5 are all based on the principle of proximity sensing. But, it is also possible to make a system based on touch-control. As an example, in a resistive touch-control system the elements can be provided on the outer surface 4 with the same structure as with proximity sensing, but each element itself has the structure of alternating stripes and spacers. Touching such an element changes the resistivity of the element and this determines the selected lighting colour and/or intensity. Evidently, other types of touch-control systems can be applied as well.

Evidently, the invention is not limited to the examples of the pyramid with the polygon-shaped base or the cylinder. Other forms for the user interface 3, like a truncated ellipsoid—of which a half-sphere is a specific example—may also be used and can be provided with the same functionality.

Summarizing, the invention relates to a lighting device 1 comprising a lighting unit 2 and a user interface 3 for controlling the lighting colour and/or intensity of the lighting unit 2. The user interface 3 comprises a sensing device 5 with a large number of conductive elements 6, which responds to the proximity of a conductive object, like for instance a human finger pointing to the user interface 3. The user interface 3 can be based on proximity sensing or on touch-control. In both cases an element 6 on the outer surface 4 of the user interface 3 is selected, which corresponds to one of the selectable colours and/or intensities of the lighting unit 2. The selected element 6 generates an output signal which is sent to a processing unit 9, which converts this output signal into a driving signal suitable for the driver circuit 8 to drive the light sources 7.

1. A lighting device (1) comprising a lighting unit (2) and a user interface (3) for controlling the lighting colour and/or intensity of the lighting unit (2), said user interface (3) having an outer surface (4) provided with a mapping of selectable lighting colours and/or intensities and a sensing device (5) for sensing a user action resulting in an output signal of the user interface (3), said output signal controlling the lighting colour and/or intensity of the lighting unit (2).

2. A lighting device (1) as claimed in claim 1, characterized in that the sensing device (5) is a proximity sensing device comprising a plurality of conductive elements (6) each being arranged to control a particular lighting colour and/or intensity.

3. A lighting device (1) as claimed in claim 2, characterized in that the conductive elements (6), when in operation, have a certain charge, a change in the charge of such a conductive element (6) by the proximity of a conductive object controlling the setting of the lighting colour and/or intensity which corresponds to said conductive element (6).

4. A lighting device (1) as claimed in claim 1, characterized in that the sensing device (5) is a touch-control device, comprising a plurality of resistive elements each being arranged to control a particular lighting colour and/or intensity when in operation, the corresponding resistive element being touched by a conductive object.

5. A lighting device (1) as claimed in claim 3, characterized in that the conductive object is the hand of a human being.

6. A lighting device (1) as claimed in claim 1, characterized in that the user interface (3) serves as a remote control for the lighting unit (2).

7. A lighting device (1) as claimed in claim 1, characterized in that the user interface (3) and the lighting unit (2) are integrated.

8. A lighting device (1) as claimed in claim 1, characterized in that the user interface (3) comprises light sources which indicate the desired lighting colour.

9. A lighting device (1) as claimed in claim 1, characterized in that the lighting unit (2) comprises light sources (7) for generating the primary lighting colours red, green and blue.

10. A lighting device (1) as claimed in claim 1, characterized in that the lighting unit (2) comprises LEDs.

11. A lighting device (1) as claimed in claim 1, characterized in that the user interface (3) is shaped as a pyramid with a polygon-shaped base (10), said pyramid having a symmetry axis (11) which is oriented perpendicular to the polygon-shaped base (11).

12. A lighting device (1) as claimed in claim 1, characterized in that the user interface (3) is shaped as a cylinder having a base (10) and a symmetry axis (11) which is oriented perpendicular to the base (10).

13. A lighting device (1) as claimed in claim 1, characterized in that the user interface (3) is shaped as a truncated ellipsoid having a base and a symmetry axis which is oriented perpendicular to the base.

14. A lighting device (1) as claimed in claim 11, characterized in that the mapping of the colour and/or intensity has two independent directions, the colour is mapped following a rotation around the symmetry axis (11) and the intensity is mapped in the direction of the symmetry axis (11).

15. A user interface (3) for controlling a lighting unit (2), having an outer surface (4) provided with a mapping of selectable lighting colours and/or intensities, said outer surface (4) further comprising a sensing device (5) for sensing a user action resulting in an output signal of the user interface (3), said output signal controls the lighting colour and/or intensity of the lighting unit (2).

16. An assembly of a lighting unit (2) and a processing unit (9) characterized in that said processing unit (9) is arranged to receive an output signal delivered by the user interface (3) of claim 15 and to convert this output signal into an input value for the lighting unit (2).

17. A method of controlling the lighting colour and/or intensity of a lighting device (1) the device comprising a lighting unit (2) and a user interface (3), having an outer surface (4) provided with a mapping of all selectable lighting colours and/or intensities, said outer surface (4) further comprising a sensing device (5), said method comprising the steps of sensing a user action for selecting a desired lighting colour and/or intensity, generating an output signal of the user interface (3), sending the output signal to a processor unit (9) which generates a signal for driving the lighting unit (2) to adjust the desired lighting colour and/or intensity.
